(19) United States
(12) Patent Application Publication
(10) Pub. No.: US 2006/0176159 A1
(43) Pub. Date: Aug. 10, 2006

(54) Wireless vehicle alarm system

(76) Inventor: Charles Chu, Banciao City (TW)

Correspondence Address: Charles CHU, P.O. Box No. 6-57, Junghe, Taipei, 235, TW

(21) Appl. No.: 11/044,168

(22) Filed: Jan. 28, 2005

(51) Int. Cl. B60R 25/10

(52) U.S. Cl. 340/426.19

(57) ABSTRACT

An apparatus for providing GPS/GPRS based vehicle alarm information to a vehicle operator is disclosed. The wireless vehicle alarm system includes at least a GPS receiver; a GPRS transceiver; an interface unit having a GPS antenna communicating with the GPS receiver, a GPRS antenna communicating with the GPRS transceiver, and plural inputs and plural outputs communicating with the vehicle protecting unit for providing a set information to remote vehicle operator; and a guarding unit connected to the interface and having a bottom for enabling to record a current position and use a pre-defined radius as a circular region to guard a vehicle, wherein if the vehicle moves out of the circular region, a report is generated to the set information and a self-guard procedure is executed.

### BACKGROUND OF THE INVENTION

(a) Field off the Invention

This invention relates to an apparatus for providing GPS/GPRS based vehicle alarm information to a vehicle operator.

(b) Description of the Prior Art

Generally, the ability to monitor in real time the location of a vehicle has many applications. For example, a stolen vehicle can be easily recovered if it is equipped with a device that reports its location. As another example, a police squad car or an ambulance can be directed to crime scene or an accident easily without requiring the driver to provide constant updates of his or her position to the dispatcher. The location of a moving vehicle can be obtained based on position information from the global positioning system (GPS) satellites. However, receiving GPS positioning information requires that the receiver is has unobstructed line-of-sight view to a GPS satellite. Such a view may not be available when the vehicle's view to the satellite is unobstructed by surrounding tall buildings. Accordingly, a system which can overcome this problem to report adequately accurate positioning information is valuable in a vehicle monitoring system operating in a city.

On the other hand, Global Positioning System (GPS) is widely introduced into the car positioning system since 1993. GPS, which is different from the radio communication system, defines longitude and latitude via electric waves from plural artificial satellites, thereby obtaining the present location. GPS, including three parts—positioning satellites, ground control set, and receiver set, is developed by the Ministry of National Defense of USA, and has been make open to public access or use for commercial and civil use. Positioning system of GPS has 24 satellites respectively disposed on 6 orbits, wherein each one is away from the ground about 20200 kilometers and takes only 12 hours to revolve around the earth. The electronic wave of orbit and time data from each satellite set is provided to the receiver for decoding and transferring into coordinate data. Furthermore, the ground control set is used for tracing and controlling GPS satellites thereby modifying the parameters of normal running and being sure the received coordinate data thereof is correct. The receiver calculates the present location thereof by means of trigonometrical survey in response to the positioning data of at least three satellites. Moreover, the moving speed and time of the receiver could be calculated by harmony with application software. If the weather is fair, the location of the receiver could be calculated more correctly via the data from 4 or more satellites.

The prior art provides a positioning unit (“mobile unit”), which includes a GPS receiver for positioning the moving vehicle. Furthermore, the mobile unit is equipped with a wireless communication capability, including Internet access, using a cellular telephony communication protocol, such as GSM, CDPD, and CDMA. Where surrounding buildings obstruct the GPS receiver, the mobile unit uses a “dead reckoning” (DR) technique to provide positioning information. In one embodiment, a gyroscope and a digital compass are provided in the mobile unit to provide this DR capability. However, the cellular telephony communication protocol, such as GSM, CDPD, and CDMA can't provide integrated and broad functions.

Therefore, it needs to provide an apparatus for providing vehicle integrated and broad alarm information to a vehicle operator by means of introducing GPS/GPRS base system for rectifying those drawbacks and limitations in operation of the prior art and solving the above problems.

### SUMMARY OF THE INVENTION

This paragraph extracts and compiles some features of the present invention; other features will be disclosed in the follow-up paragraph. It is intended to cover various modifications and similar arrangements included within the spirit and scope of the appended claims, and this paragraph also is considered to refer.

It is an object of the present invention to provide an apparatus for providing vehicle integrated and broad alarm information to a vehicle operator by means of introducing GPS/GPRS base system combined with a guarding unit.

In accordance with an aspect of the present invention, the wireless vehicle alarm system includes a GPS receiver; a GPRS transceiver; an interface unit having a GPS antenna communicating with the GPS receiver, a GPRS antenna communicating with the GPRS transceiver, and plural inputs and plural outputs communicating with the vehicle protecting unit for providing a set information to remote vehicle operator; and a guarding unit connected to the interface and having a bottom for enabling to record a current position and use a pre-defined radius as a circular region to guard a vehicle, wherein if the vehicle moves out of the circular region, a report is generated to the set information and a self-guard procedure is executed.

Preferably, the interface unit further includes a connector and connected with a computer thereof for processing the set information.

Certainly, the set information can be one selected from a group of a unit's ID, a time, a GPS's latitude and longitude, a speed, a direction, a temperature, a device's status, an event number, a report configuration parameters, and a mixture thereof.

It is another object of the present invention to provide an apparatus for integrating and providing a vehicle alarm information to a vehicle operator by means of communicating with a GPS/GPRS transceiver.

According to the above aspect of the present invention, the wireless vehicle alarm integrated equipment includes a GPS antenna for communicating with a GPS receiver; a GPRS antenna for communicating with a GPRS transceiver; plural inputs and plural outputs communicating with a vehicle protecting unit for providing a set information, wherein the vehicle protecting unit further includes a guarding unit connected to the plural inputs and plural outputs and having a bottom for enabling to record a current position and use a pre-defined radius as a circular region to guard a vehicle; and a connector for connecting with a computer thereof for processing the set information to remote vehicle operator.

Preferably, the set information is one selected from a group of a unit's ID, a time, a GPS's latitude and longitude, a speed, a direction, a temperature, a device's status, an event number, a report configuration parameters, and a mixture thereof.

Preferably, the vehicle protecting unit includes an optional output, a valet switch, a car alarm, a shock sensor, a temperature sensor, central locking interface connections, a fuel pump, a horn, a trunk, and a lamp.

Preferably, the wireless vehicle alarm integrated equipment further comprises a battery for providing the wireless vehicle alarm integrated equipment with a power.

According to the above aspect of the present invention, the wireless vehicle alarm integrated equipment includes a GPS antenna for communicating with a GPS receiver; a GPRS antenna for communicating with a GPRS transceiver; plural inputs and plural outputs communicating with a guarding unit connected to the plural inputs and plural outputs and having a bottom for enabling to record a current position and use a pre-defined radius as a circular region to guard a vehicle, wherein if the vehicle moves out of the circular region, a report is generated to a set information and a self-guard procedure is executed; and a connector for connecting with a computer thereof for processing the set information to remote vehicle operator.

Preferably, the wireless vehicle alarm integrated equipment further comprises plural LED for indicating.

Certainly, the plural inputs and plural outputs can be built-in 7 outputs respectively connected to an optional output, a valet switch, a car alarm, a shock sensor, a temperature sensor, a central locking interface connections, and a fuel pump; and 5 inputs respectively connected to a solar battery, a +12V battery, a horn, a trunk, and a lamp for performing essential alarm functions and providing the set information.

Preferably, the set information is one selected from a group of a unit's ID, a time, a GPS's latitude and longitude, a speed, a direction, a temperature, a device's status, an event number, a report configuration parameters, and a mixture thereof.

The present invention needs not be limited to the above embodiment. The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 illustrates an embodiment of the wireless vehicle alarm system according to the present invention;

FIGS. 2(a)-2(b) illustrate an embodiment of the GPS/GPRS based wireless vehicle alarm integrated equipment according to the present invention;

FIG. 3 illustrates a functional diagram of the GPS/GPRS based wireless vehicle alarm integrated equipment according to the present invention.

### DETAILED DESCRIPTION OF THE PREFERRED EMBODIMENT

The present invention discloses an apparatus for providing vehicle integrated and broad alarm information to a vehicle operator by means of introducing GPS/GPRS base system, and the objects and advantages of the present invention will become more readily apparent to those ordinarily skilled in the art after reviewing the following detailed description. The present invention needs not be limited to the following embodiment.

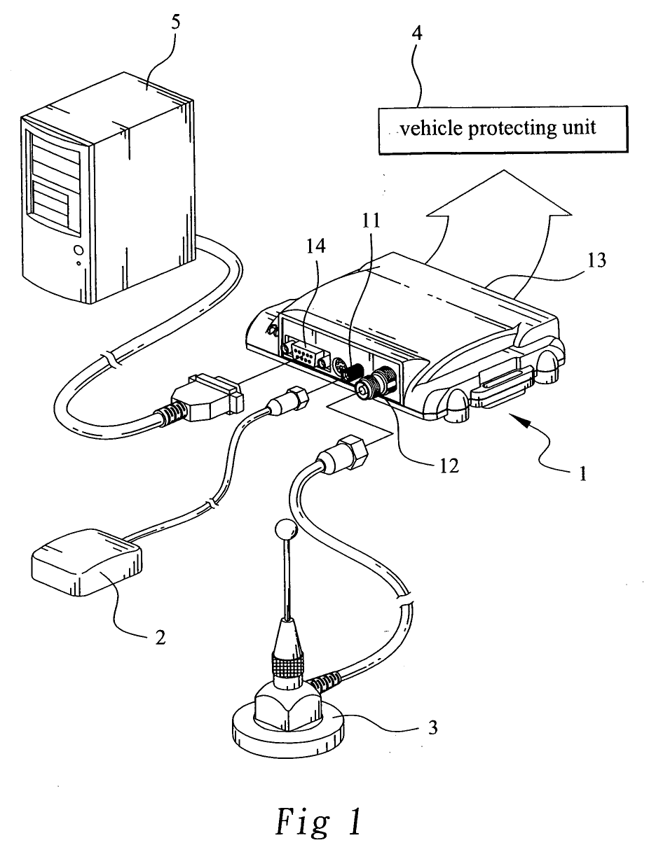

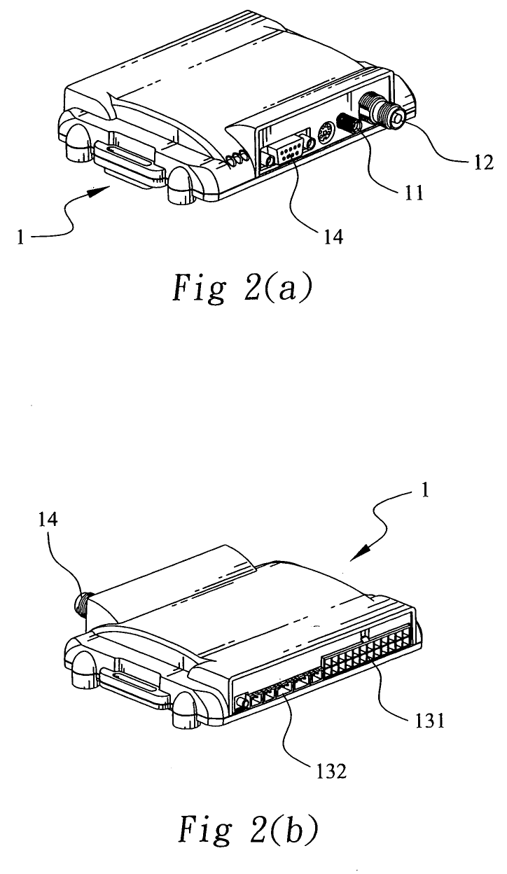

Please refer to FIG. 1 and FIGS. 2(a)-2(b). They illustrate a wireless vehicle alarm system includes a GPS receiver 2; a GPRS transceiver 3; and an interface unit 1 having a GPS antenna 11 communicating with the GPS receiver 1, a GPRS antenna 12 communicating with the GPRS transceiver 2, and plural inputs and plural outputs 13 communicating with the vehicle protecting unit 4 for providing a set information to remote vehicle operator; and a guarding unit (a vehicle protecting unit) 4 connected to the interface and having a bottom (not shown) for enabling to record a current position and use a pre-defined radius as a circular region to guard a vehicle, wherein if the vehicle moves out of the circular region, a report is generated to the set information and a self-guard procedure is executed. In practice, the interface unit 1 further includes a connector 14 and connected with a computer 5 thereof for processing the set information.

Please refer to FIGS. 2(a)-2(b). They illustrate an embodiment of the GPS/GPRS based wireless vehicle alarm integrated equipment according to the present invention. The wireless vehicle alarm integrated equipment includes a GPS antenna 11 for communicating with a GPS receiver 1; a GPRS antenna 12 for communicating with a GPRS transceiver 12; plural inputs 131 and plural outputs 132 communicating with a vehicle protecting unit for providing a set information; a connector 14 for connecting with a computer thereof for processing the set information to remote vehicle operator; and a guarding unit 4 connected to the interface and having a bottom for enabling to record a current position and use a pre-defined radius as a circular region to guard a vehicle, wherein if the vehicle moves out of the circular region, a report is generated to the set information and a self-guard procedure is executed.

The present invention utilizes the GPS and car alarm functions in one unit. You can monitor the vehicle location and control the car alarm remotely. In addition, the unit will send event report if any trigger occurs. It has built-in 7 outputs and 5 inputs to perform essential alarm functions. More importantly, it can be connected with series alarm to provide full protection.

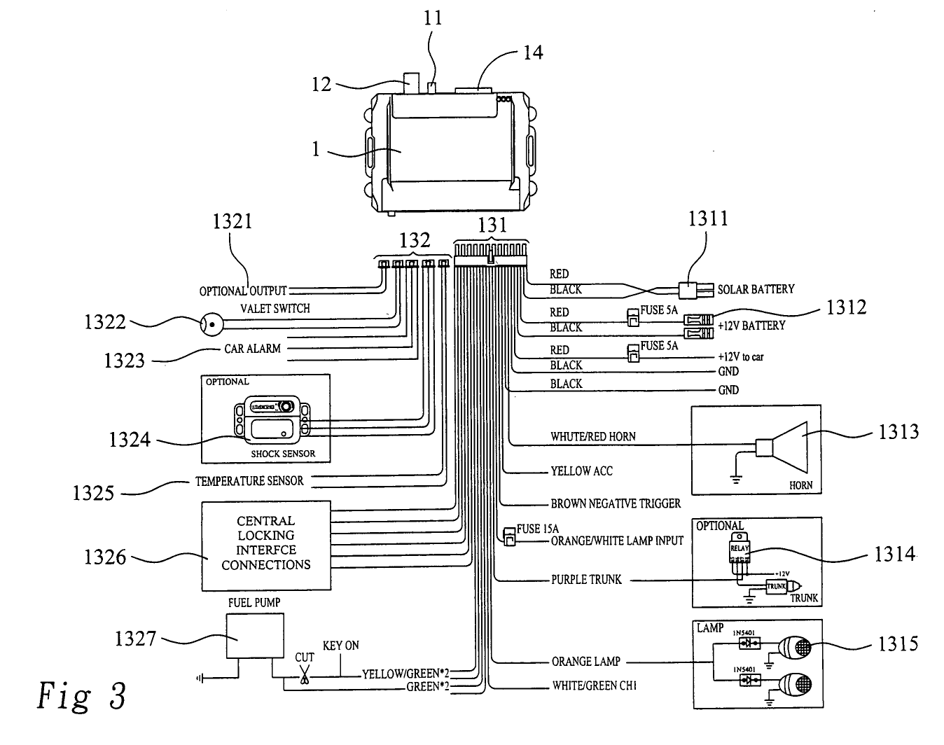

Please further refer to FIG. 3. It illustrates a functional diagram of the GPS/GPRS based wireless vehicle alarm integrated equipment according to the present invention. The wireless vehicle alarm integrated equipment includes a GPS antenna 11 for communicating with a GPS receiver; a GPRS antenna 12 for communicating with a GPRS transceiver; plural inputs 131 and plural outputs 132 communicating with a vehicle protecting unit for performing essential alarm functions and providing a set information; a connector 14 for connecting with a computer thereof for processing the set information to remote vehicle operator; and a guarding unit 4 connected to the interface and having a bottom for enabling to record a current position and use a pre-defined radius as a circular region to guard a vehicle, wherein if the vehicle moves out of the circular region, a report is generated to the set information and a self-guard procedure is executed. Preferably, the wireless vehicle alarm integrated equipment further comprises plural LED for indicating. In practice, the plural inputs 131 and plural outputs 132 can be built-in 7 outputs respectively connected to an optional output 1321, a valet switch 1322, a car alarm 1323, a shock sensor 1324, a temperature sensor 1325, a central locking interface connections 1326, and a fuel pump 1327; and 5 inputs respectively connected to a solar battery 1311, a +12V battery 1312, a horn 1313, a trunk 1314, and a lamp 1315 for performing essential alarm functions and providing the set information. Preferably, the set information is one selected from a group of a unit's ID, a time, a GPS's latitude and longitude, a speed, a direction, a temperature, a device's status, an event number, a report configuration parameters, and a mixture thereof.

In the embodiment, the standard report sent by the unit includes the information: (1) unit's ID, (2) time, (3) GPS's latitude and longitude, (4) speed, (5) direction, (6) temperature, (7) device's status, (8) event number, and (9) report configuration parameters. wherein, (1) Unit's ID: each device has its own unique ID and must be registered in the server in order to perform monitoring or controlling. (2) Time: report time in Greenwich Mean time zone. (3) GPS's latitude and longitude. (4) Speed: in km/H (5) Direction: in degree to the North. (6) Temperature: in Celsius. If the temperature is not connected, ‘NA’ will be shown in this field. (7) Device's status: there are 32 states to represent the I/O and working modes for the both the device and the external alarm. (8) Event number: all the generated reports will include a unique event number to indicate why it has been sent. (9) Report configuration parameters: user can remotely change the report configuration, and the configuration parameters will be shown in this field.

Additionally, the present invention further introduces a guarding unit into the system for enabling to record a current position and use a pre-defined radius as a circular region to guard a vehicle, wherein if the vehicle moves out of the circular region, a report is generated to the set information and a self-guard procedure is executed. The novel guarding unit is called as Immediate Geofence Control unit via an external switch or transmitter and provides Immediate Geofence function. Immediate-Geofence function is a circular type Geofence that can be activated or deactivated from a single button. When activated, the system will record the current position and use the pre-defined radius as a circular Geofence to guard the vehicle. If the vehicle moves out of the preset Geofence zone, a report will be generated to the server and start self-guard procedure. User can deactivate the self-Geofence at any time by pressing the button again. If the GPS cannot be located when the Immediate Geofence function is been executed, a guarding unit, GT-8000 will be used the last known position as the origin of the circular Geofence zone to perform the protection.

Furthermore, the embodiment of the present invention supports both UDP and TCP socket communication. The server IP, port number and socket type can be selected from the PC-setup program or remote server command. In addition, the connection can be swap over to any server IP or port (either UDP or TCP) via the air command. Flash memory for recording reports up to 1000 reports. It can be read out from the PC setup program via serial port. A 12V 1.2 A/H backup battery is included to maintain maximum performance. In addition, the system has a built-in rechargeable battery (4.8V 80 mA/H) for emergency use. The system will send an emergency report when all of the external power is unplugged. Three LED indicate the status of the POWER, GPRS signal and GPS signal.

Therefore, the present invention provides an apparatus for providing vehicle integrated and broad alarm information to a vehicle operator by means of introducing GPS/GPRS base system.

Accordingly, the present invention possesses many outstanding characteristics, effectively improves upon the drawbacks associated with the prior art in practice and application, produces practical and reliable products, bears novelty, and adds to economical utility value. Therefore, the present invention exhibits a great industrial value. While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A wireless vehicle alarm system comprising:
a GPS receiver;
a GPRS transceiver;
an interface unit having a GPS antenna communicating with the GPS receiver, a GPRS antenna communicating with the GPRS transceiver, and plural inputs and plural outputs communicating with the vehicle protecting unit for providing a set information to remote vehicle operator; and
a guarding unit connected to the interface and having a bottom for enabling to record a current position and use a pre-defined radius as a circular region to guard a vehicle, wherein if the vehicle moves out of the circular region, a report is generated to the set information and a self-guard procedure is executed.

2. The wireless vehicle alarm system according to claim 1, wherein the interface unit further comprises a connector and connected with a computer thereof for processing the set information.

3. The wireless vehicle alarm system according to claim 1, wherein the set information is one selected from a group of a unit's ID, a time, a GPS's latitude and longitude, a speed, a direction, a temperature, a device's status, a event number, a report configuration parameters, and a mixture thereof.

4. A wireless vehicle alarm integrated equipment comprising:
a GPS antenna for communicating with a GPS receiver;
a GPRS antenna for communicating with a GPRS transceiver;
plural inputs and plural outputs communicating with a vehicle protecting unit for providing a set information, wherein said vehicle protecting unit further comprises a guarding unit connected to the plural inputs and plural outputs and having a bottom for enabling to record a current position and use a pre-defined radius as a circular region to guard a vehicle; and
a connector for connecting with a computer thereof for processing the set information to remote vehicle operator.

5. The wireless vehicle alarm integrated equipment according to claim 4, wherein the set information is one selected from a group of a unit's ID, a time, a GPS's latitude and longitude, a speed, a direction, a temperature, a device's status, a event number, a report configuration parameters, and a mixture thereof.

6. The wireless vehicle alarm integrated equipment according to claim 4, wherein the vehicle protecting unit includes an optional output, a valet switch, a car alarm, a shock sensor, a temperature sensor, a central locking interface connections, a fuel pump, a horn, a trunk, and a lamp.

7. The wireless vehicle alarm integrated equipment according to claim 4, further comprises a battery for providing the wireless vehicle alarm integrated equipment with a power.

8. A wireless vehicle alarm integrated equipment comprising:
a GPS antenna for communicating with a GPS receiver;
a GPRS antenna for communicating with a GPRS transceiver;
plural inputs and plural outputs communicating with a guarding unit connected to the plural inputs and plural outputs and having a bottom for enabling to record a current position and use a pre-defined radius as a circular region to guard a vehicle, wherein if the vehicle moves out of the circular region, a report is generated to a set information and a self-guard procedure is executed; and a connector for connecting with a computer thereof for processing the set information to remote vehicle operator.

9. The wireless vehicle alarm integrated equipment according to claim 8, further comprises plural LED for indicating.

10. The wireless vehicle alarm integrated equipment according to claim 8, wherein the plural inputs and plural outputs are built-in 7 outputs respectively connected to an optional output, a valet switch, a car alarm, a shock sensor, a temperature sensor, a central locking interface connections, and a fuel pump; and 5 inputs respectively connected to a solar battery, a +12V battery, a horn, a trunk, and a lamp for performing essential alarm functions and providing the set information.

11. The wireless vehicle alarm integrated equipment according to claim 8, wherein the set information is one selected from a group of a unit's ID, a time, a GPS's latitude and longitude, a speed, a direction, a temperature, a device's status, a event number, a report configuration parameters, and a mixture thereof.
